(19) United States
(12) Patent Application Publication
(10) Pub. No.: US 2025/0298456 A1
(43) Pub. Date: Sep. 25, 2025

(54) RECEIVING DEVICE AND POWER MANAGING METHOD THEREOF

(71) Applicant: SAMSUNG ELECTRONICS CO., LTD., Suwon-si (KR)

(72) Inventors: SUKGYUN LIM, Suwon-si (KR); SOOJOO LEE, Suwon-si (KR); HYUNWOOK LIM, Suwon-si (KR)

(73) Assignee: SAMSUNG ELECTRONICS CO., LTD., Suwon-si (KR)

(21) Appl. No.: 18/939,032

(22) Filed: Nov. 6, 2024

(30) Foreign Application Priority Data
Mar. 25, 2024 (KR) 10-2024-0040468

(51) Int. Cl. G06F 1/3237; G06F 1/04

(52) U.S. Cl. CPC G06F 1/3237; G06F 1/04

(57) ABSTRACT

There is provided a receiving device including a reception circuit provided in a physical area and a controller provided in a logical area. The reception circuit generates data based on a differential signal received from a transmitter, and transfers the data to the logical area. The controller determines an operation mode based on the data, generates an operation control signal based on the operation mode, and transfers the generated operation control signal to the reception circuit.

### CROSS-REFERENCE TO RELATED APPLICATION

This application is based on and claims priority to and the benefit of Korean Patent Application No. 10-2024-0040468 filed in the Korean Intellectual Property Office on Mar. 25, 2024, the entire contents of which is incorporated herein by reference.

### BACKGROUND

### 1. Field

The disclosure relates to a receiving device and a power managing method of the receiving device.

### 2. Description of the Related Art

Recently, various types of electronic devices have been widely used. Electronic devices provide unique functions depending on the operations of various electronic circuits included in them. An electronic device may operate independently or may operate while communicating with other electronic devices. Electronic devices may include transmitters and receivers to communicate with other electronic devices.

A receiver in an electronic device can receive data from a transmitter. A transmitter may refer to a transmitter within the same electronic device or a transmitter of another electronic device. The receiver may generate data and clock from the received signals. In the receiver, the clock generation block operates even in periods when data is not generated, and thereby the receiver unnecessarily consumes power. As such, there is research to reduce the power consumption of the receiver.

### SUMMARY

One or more aspects of the disclosure relate to providing a power managing method and a receiving device capable of reducing power consumption.

According to an aspect of the disclosure, there is provided a receiving device including: a reception circuit provided in a physical area of the receiving device, the reception circuit configured to: generate data based on a differential signals received from a transmitter, and transfer the data to a logical area of the receiving device; and a controller provided in the logical area, the controller configured to: determine an operation mode based on the data, generate an operation control signal based on the operation mode, and transfer the operation control signal to the reception circuit.

According to another aspect of the disclosure, there is provided a power managing method of a receiving device, including: generating, by a data lane of the receiving device, data based on a first input signal; generating, by a clock lane of the receiving device, a clock based on a second input signal; determining, by the data lane, an operation mode of the data lane based on the data; and turning off a low-power receiver of the clock lane based on the operation mode being a low-power mode.

According to another aspect of the disclosure, there is provided a power managing method of a receiving device, including: receiving a pulse signal from a synchronization pin; determining whether a signal characteristic of the pulse signal satisfies a first condition; turning off a receiver of the receiving device based on the signal characteristic satisfying the first condition; and generating a synchronization signal based on the signal characteristic not satisfying the first condition.

### BRIEF DESCRIPTION OF DRAWINGS

Embodiments herein are illustrated in the accompanying drawings, throughout which like reference letters indicate corresponding parts in the various figures. The embodiments herein will be better understood from the following description with reference to the following illustrative drawings. Embodiments herein are illustrated by way of examples in the accompanying drawings, and in which:

FIG. 1 is a schematic block diagram of an electronic system according to an embodiment.

FIG. 2 is a block diagram of a receiver according to an embodiment.

FIG. 3 is a block diagram of a receiver according to an embodiment.

FIG. 4 is a circuit diagram of a resistance circuit according to an embodiment.

FIG. 5 is a circuit diagram of a low-power receiver according to an embodiment.

FIG. 6 is a timing diagram for explaining an operation of a receiver according to an embodiment.

FIG. 7 is a timing diagram for explaining an operation of a receiver according to an embodiment.

FIG. 8 is a timing diagram for explaining an operation of a receiver according to an embodiment.

FIG. 9 is a block diagram of a receiver according to an embodiment.

FIG. 10 is a block diagram of a reception circuit according to an embodiment.

FIG. 11 is a circuit diagram of a low-power receiver according to an embodiment.

FIG. 12 is a flowchart of a power managing method of a receiver according to an embodiment.

FIG. 13 is a flowchart of a power managing method of a receiver according to an embodiment.

FIG. 14 is a block diagram showing an electronic system including a receiver according to an embodiment.

FIG. 15 is a block diagram showing an electronic system including a receiver according to an embodiment.

FIG. 16 is a diagram for explaining a semiconductor system according to an embodiment.

### DETAILED DESCRIPTION

In the following detailed description, only certain embodiments of the disclosure have been shown and described, simply by way of illustration. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification. In a flowchart described with reference to the drawings, an order of operations may be changed, several operations may be merged, some operations may be divided, and specific operations may not be performed.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

In addition, expressions written in the singular may be construed in the singular or plural unless an explicit expression such as “one” or “single” is used. Terms including ordinal numbers such as first, second, and the like will be used only to describe various components, and are not to be interpreted as limiting these components. These terms may be used for the purpose of distinguishing one constituent element from other constituent elements.

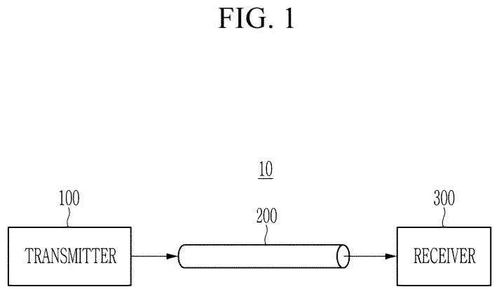

FIG. 1 is a schematic block diagram of an electronic system according to an embodiment.

Referring to FIG. 1, an electronic system 10 may include a transmitter 100 and a receiver 300. Each of the transmitter 100 and the receiver 300 may be implemented to be included in different semiconductor devices (or electronic devices). For example, the transmitter 100 may be provided in a first electronic device and the receiver 300 may be provided in a second electronic device. However, the disclosure is not limited thereto, and as such, according to an embodiment, the transmitter 100 and the receiver 300 may be implemented to be included in one semiconductor device. For example, the transmitter 100 and the receiver 300 may be provided in the same first electronic device.

The electronic system 10 may be provided with a communication channel 200 between the transmitter 100 and the receiver 300. In an embodiment, the communication channel 200 may be implemented as a wired channel for wired communication, or implemented as a radio channel for wireless communication. For example, the wired channel may include, but is not limited to, a copper line on a substrate. The substrate may be a printed circuit board (PCB), or the like, but is not particularly limited to the PCB. The transmitter 100 may transmit data to the receiver 300 through the communication channel 200.

In an embodiment, the transmitter 100 may be a host, and the receiver 300 may be a memory device. The host may include a central processing unit (CPU), a graphics processing unit (GPU), or an application processor (AP), or the like. The memory device may include a volatile memory or a non-volatile memory, or the like.

In an embodiment, the transmitter 100 may be a host, and the receiver 300 may be a peripheral device. The peripheral device may include a display device, a camera device, a communication device, a storage device, or the like. However, the disclosure is not limited thereto, and as such, according to another embodiment, the transmitter 100 and the receiver 300 may be implemented as various components that exchange data by using the communication channel 200. According to some embodiments, the receiver 300 may transmit data to the transmitter 100, and the transmitter 100 may also receive data from the receiver 300.

In an embodiment, the communication channel 200 may include wires of physical layer D-PHY (Display Serial Interface physical layer) or C-PHY (Camera Serial Interface physical layer) of the protocol defined by Mobile Industry Processor Interface (MIPI) alliance. The host and the device (e.g., a display device, a camera device, or the like) may exchange data and control information by using wires of the communication channel 200.

In an example case in which the communication channel 200 is D-PHY, the communication channel 200 may include two wires for a data lane and two wires for a clock lane. A receiver 300 may receive a data signal of the data lane and a clock signal of the clock lane through the communication channel 200. The receiver 300 may determine an operation mode of the data lane based on the data signal. The operation mode may include, but is not limited to, a low-power mode, a high-speed mode, or the like. The receiver 300 may control turning on and off of a reception circuit based on the operation mode. In an example case in which the data lane is the low-power mode, the receiver 300 may turn off the reception circuit of the clock lane. Also, in an example case in which the data lane is not the high-speed mode, the receiver 300 may turn off the reception circuit of the clock lane. In an embodiment, the turning off the reception circuit of the clock lane may be understood as turning off at least one of a high-speed receiver included in the reception circuit, a resistance circuit connected to the high-speed receiver, and a low-power receiver. However, the disclosure is not limited thereto, and as such, may include turning off another component of the reception circuit.

In an example case in which the communication channel 200 is C-PHY, signals transmitted from the transmitter 100 to the receiver 300 may be a clock embedded signal. For example, signals transmitted from the transmitter 100 to the receiver 300 may include clock information. The communication channel 200 may include three wires for transferring three states (e.g., states of +1, 0, and −1, which refer to specific voltage levels used in the signaling protocol of the C-PHY interface). The receiver 300 may determine a lane state based on signals received through the wires. The receiver 300 may control turning on and off of the reception circuit based on the lane state. In an example case in which the lane state is a stop state (e.g., LP-111 of C-PHY specification), the receiver 300 may turn off the reception circuit.

According to an embodiment, the transmitter 100 may transmit a power-down signal to the receiver 300. The power-down signal may be transferred through a synchronization pin. The synchronization pin may be different from the pin of the above-described wire. In an example case in which a power-down signal is received from the transmitter 100, the receiver 300 may turn off the entire reception circuit. According to an embodiment, the receiver 300 may receive a synchronization signal through the synchronization pin. The receiver 300 may generate at least one of a horizontal synchronization signal and a vertical synchronization signal based on the synchronization signal.

As such, the receiver 300 may decrease power consumption, and the power-efficiency of the electronic system 10 may be improved.

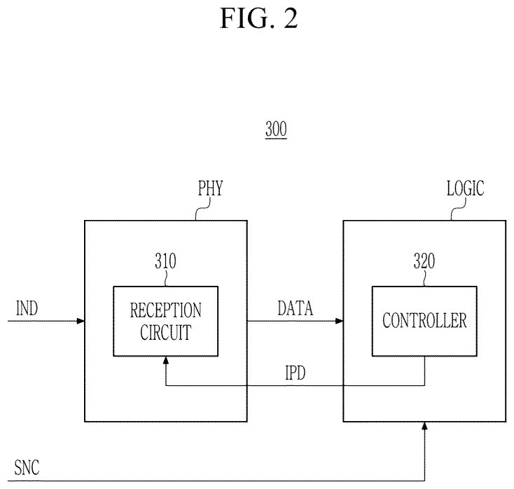

FIG. 2 is a block diagram of a receiver according to an embodiment.

Referring to FIG. 2, according to an embodiment, the receiver 300 may receive data IND from a transmitter (e.g., transmitter 100 of FIG. 1). The receiver 300 may include a physical area PHY and a logical area LOGIC. The physical area PHY may perform a skew calibration on the data IND and generate data DATA. For example, the skew of the clock and data may be compensated based on the skew calibration.

The physical area PHY may include the reception circuit 310. The reception circuit 310 may include a high-speed receiver for high-rate data transmission and a low-power receiver for low-power operation. The low-power receiver may be used for control an operation of the reception circuit 310, but the disclosure is not limited thereto.

The high-speed receiver and the low-power receiver may operate based on an operation mode. For example, in an example case in which the operation mode is a low-power mode, the low-power receiver may operate. In an example case in which the operation mode is a high-speed mode, the high-speed receiver may operate. For example, the operation mode may be determined based on a level (e.g., voltage level) of the data IND.

According to an embodiment, in the high-speed mode, the high-speed receiver may operate to receive a differential signal of the data IND, and generate digital value based on the differential signal. The high-speed receiver may transfer a digital value to the logical area LOGIC. According to an embodiment, in the low-power mode, the low-power receiver may operate to generate an output value based on the data IND and a reference voltage. For example, the low-power receiver may output a high level when the data IND is higher than a first reference voltage, and may output a low level when the data IND is lower than a second reference voltage. The low-power receiver may transfer the output value to the logical area LOGIC. Accordingly, the data DATA may include the output of the high-speed receiver and the output of the low-power receiver. The low-power receiver may be implemented as a single-ended amplifier.

The physical area PHY may transfer the data DATA to the logical area LOGIC. According to an embodiment, the physical area PHY may further include a restoration circuit, a low-power contention detector, a deserializer, or the like.

The logical area LOGIC may receive the data DATA from the physical area PHY. The logical area LOGIC may include a controller 320. The controller 320 may generate an operation control signal IPD based on the data DATA. The operation control signal IPD may be a signal for controlling an operation of the reception circuit 310. For example, the operation control signal IPD may be a signal for turning on and turning off the reception circuit 310. That is, the reception circuit 310 may be turned on and off based on the operation control signal IPD. According to an embodiment, the controller 320 may generate the operation control signal IPD for controlling each component included in the reception circuit 310. For example, the operation control signal IPD may be configured to turn or turn off one or more components included in the reception circuit 310. The logical area LOGIC may further include a link layer, a packet decoder, or the like.

In addition, the controller 320 may receive a synchronization signal SNC. The synchronization signal SNC may include pulses of various properties. According to an embodiment, a transmitter may transfer the control information to the receiver by using pulses of various properties. For example, a pulse of a first pulse width may indicate generation of the synchronization signal, and a pulse of a second pulse width may indicate power-down. The synchronization signal SNC may include a periodic pulse of the first pulse width. The transmitter may transmit the synchronization signal SNC to the receiver 300. The controller 320 may generate the operation control signal IPD based on the synchronization signal SNC.

The receiver 300 may receive the data IND and the synchronization signal SNC through different pins. For example, the receiver 300 may receive the data IND through a first pin, and may receive the synchronization signal SNC through a second pin. In some embodiments, the second pin may be a synchronization pin.

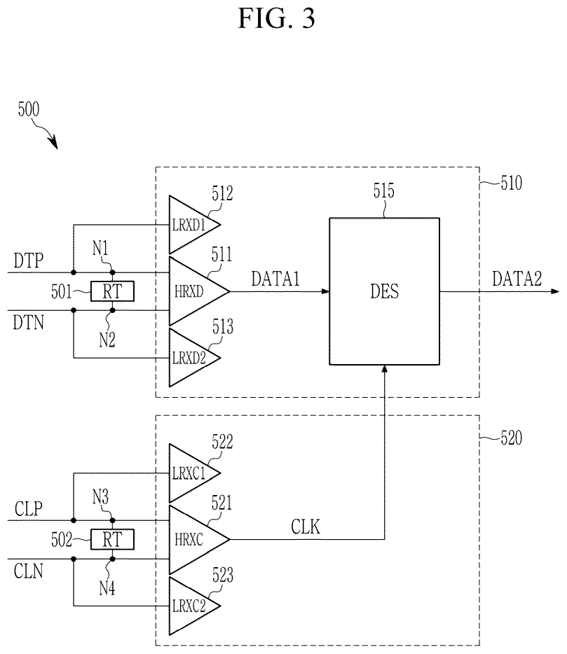

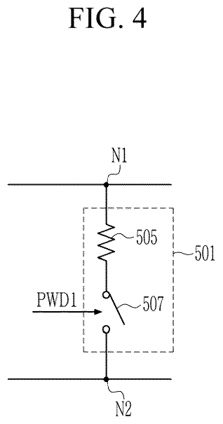

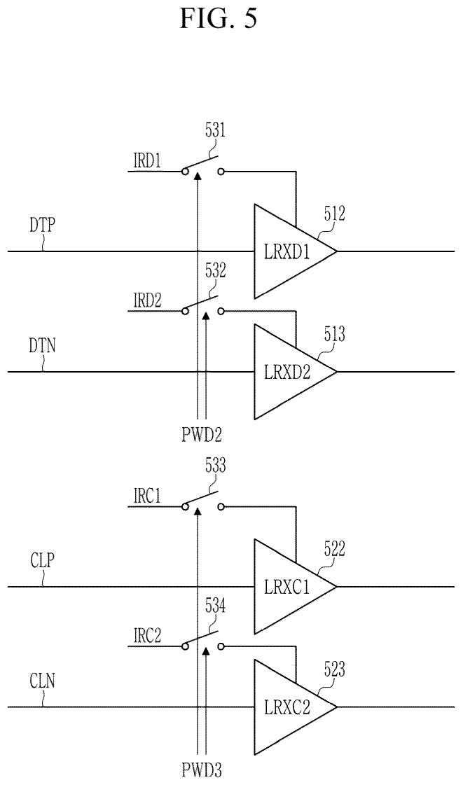

FIG. 3 is a block diagram of a receiver according to an embodiment. FIG. 4 is a circuit diagram of a resistance circuit according to an embodiment. FIG. 5 is a circuit diagram of the low-power receiver according to an embodiment.

Referring to FIG. 3, according to an embodiment, a receiver 500 may be included in the physical area of D-PHY. The receiver 500 may include a data block 510 for processing the data received from a transmitter and a clock block 520 for processing the clock received from the transmitter.

The data block 510 may include a first high-speed receiver (HRXD) 511, a first low-power receiver (LRXD1) 512, a second low-power receiver (LRXD2) 513, and a deserializer (DES) 515. The first high-speed receiver 511 may receive the data signals DTP and DTN from the transmitter. The first data signal DTP and the second data signal DTN may be differential signals. The first high-speed receiver 511 may receive the data signals DTP and DTN through two input ends. For example, the first high-speed receiver 511 may receive a first data signal DTP through a first input node and receive a second data signal and DTN through a second input node. According to an embodiment, the data block 510 may further include a low-power contention detector, a low-power transmitter, or the like.

The receiver 500 may further include a first resistance circuit (RT) 501 for connecting two input ends of the first high-speed receiver 511. The first resistance circuit 501 may be provided between nodes N1 and N2. The nodes N1 and N2 may be connected to the two input ends of the first high-speed receiver 511. The first resistance circuit 501 may include a resistor and a switch. The resistor may be understood as a terminating resistance. The switch may be opened and closed based on the control signal. For example, according to the opening and the closing of the switch, the nodes N1 and N2 may be connected or opened. The switch may open and close based on control signals of a controller (e.g., controller 320 of FIG. 2) of a logical area (e.g., LOGIC of FIG. 2). That is, according to the operation of the first resistance circuit 501, the first high-speed receiver 511 may be turned on and off. For example, in an example case in which the switch of the first resistance circuit 501 is opened, the first high-speed receiver 511 may be turned off, and in an example case in which the switch of the first resistance circuit 501 is closed, the first high-speed receiver 511 may be turned on. According to an embodiment, the first resistance circuit 501 may also be implemented to be included in the first high-speed receiver 511. The first high-speed receiver 511 may generate the data DATA1 based on the data signals DTP and DTN. The data DATA1 may be input into the deserializer 515 as a digital value.

The first low-power receiver 512 may receive the first data signal DTP. An input end of the first low-power receiver 512 may be connected to the node N1. The first low-power receiver 512 may generate signals based on the first data signal DTP and a reference voltage. For example, the first low-power receiver 512 may output the high level based on the first data signal DTP being higher than the first reference voltage, and may output the low level based on the first data signal DTP being lower than the second reference voltage. The first low-power receiver 512 may also filter the noise of the first data signal DTP. The first low-power receiver 512 may transfer the output signal to the logical area.

The second low-power receiver 513 may receive the second data signal DTN. The second data signal DTN may be the differential signal of the first data signal DTP. An input end of the second low-power receiver 513 may be connected to a node N2. The second low-power receiver 513 may generate signals based on the second data signal DTN and a reference voltage. The contents described with respect to the first low-power receiver 512 may be equally applied to the second low-power receiver 513. Accordingly, redundant description will be omitted.

The clock block 520 may include a second high-speed receiver (HRXC) 521, a third low-power receiver (LRXC1) 522, and a fourth second low-power receiver (LRXC2) 523. The second high-speed receiver 521 may receive a first clock signal CLP and a second clock signal CLN from the transmitter. The first clock signal CLP and the second clock signal CLN may be the differential signal. The second high-speed receiver 521 may receive the signals CLP and CLN through two input ends.

The receiver 500 may further include a second resistance circuit 502 for connecting two input ends of the second high-speed receiver 521. The second resistance circuit 502 may be provided between nodes N3 and N4. The nodes N3 and N4 may be connected to two input ends of the second high-speed receiver 521. The second resistance circuit 502 may include a resistor and a switch. The resistor may be understood as a terminating resistance. The switch may be opened and closed based on the control signal, and according to opening and closing of the switch, the nodes N3 and N4 may be connected or opened. The switch may be opened and closed the control signal of based on the controller. That is, according to the operation of the second resistance circuit 502, the second high-speed receiver 521 may be turned on and off. For example, in an example case in which the switch of the second resistance circuit 502 is opened, the second high-speed receiver 521 may be turned off, and in an example case in which the switch of the second resistance circuit 502 is closed, the second high-speed receiver 521 may be turned on. According to an embodiment, the second resistance circuit 502 may also be implemented to be included in the second high-speed receiver 521. The second high-speed receiver 521 may generate a clock CLK based on the clock the signals CLP and CLN. The second high-speed receiver 521 may transfer the clock CLK to the deserializer 515. The deserializer 515 may generate the data DATA2 by deserializing the data DATA1 based on the clock CLK. The deserializer 515 may transfer the data DATA2 to the logical area.

The third low-power receiver 522 may receive the first clock signal CLP. An input end of the third low-power receiver 522 may be connected to the node N3. The third low-power receiver 522 may generate signals based on the first clock signal CLP and a reference voltage. The third low-power receiver 522 may transfer the output signal to the logical area.

The fourth low-power receiver 523 may receive the second clock signal CLN. The second clock signal CLN may be the differential signal of the first clock signal CLP. An input end of the fourth low-power receiver 523 may be connected to a node N4. The fourth low-power receiver 523 may generate signals based on the second clock signal CLN and a reference voltage.

The first high-speed receiver 511, the second high-speed receiver 521, the first low-power receiver 512, the second low-power receiver 513, the third low-power receiver 522, and the fourth low-power receiver 523 may be included in the reception circuit of the receiver 500. According to an embodiment, the reception circuit may also further include resistance circuits 501 and 502. Components of the reception circuit may be turned on and off based on the control of the controller. For example, the controller may turn on and off at least one of the first and second high-speed receivers 511 and 521 and the first to fourth low-power receivers 512, 513, 522, and 523, by using the control signal.

In an embodiment, the controller may turn off the first and second high- speed receivers 511 and 521 by opening the resistance circuits 501 and 502. In an embodiment, the controller may turn off the first to fourth low-power receivers 512, 513, 522, and 523 by blocking the current input to the first to fourth low-power receivers 512, 513, 522, and 523.

Referring to FIG. 3 and FIG. 4, the first resistance circuit 501 according to an embodiment may include a resistor 505 and a switch 507. The resistor 505 may also be understood as an impedance component between the node N1 and the node N2. The switch 507 may be implemented as a transistor.

The switch 507 may be opened and closed based on a control signal PWD1. For example, the controller may generate the control signal PWD1 and transit the control signal PWD1 to the switch 507. The control signal PWD1 may be included in an operation control signal (e.g., IPD of FIG. 2). In some embodiments, the reception circuit may also generate the control signal PWD1 based on the operation control signal. The switch 507 may be closed based on the control signal PWD1 being a first level, and may be opened basd on the control signal PWD1 being a second level. For example, the control signal PWD1 may be received at a gate of the switch 507. The first level may be the high level, the second level may be the low level, but the disclosure is not limited thereto.

The controller may turn off the high-speed receiver 511 by opening the switch 507. The controller may turn on the high-speed receiver 511 by closing the switch 507.

In an embodiment, in a case in which the power-down indication (e.g., the pulse of the second pulse width in FIG. 2) is received from the transmitter, the controller may generate the control signal PWD1 of the second level. In the case in which the power-down indication is received, the controller may turn off the first and second high-speed receivers 511 and 521 and the first to fourth low-power receivers 512, 513, 522, and 523. That is, in the case in which the power-down indication is received, the controller may turn off components of the receiver 500.

In an embodiment, in a case in which the data block 510 enters a first mode, the controller may turn off the second high-speed receiver 521 of the clock block 520. For example, the controller may generate the control signal for opening the switch of the second resistance circuit 502 and transmit the control signal to the switch. The switch may be opened based on the control signal of the second level, and the second high-speed receiver 521 may be turned off. In a case in which the data block 510 exits from the first mode, the controller may generate the control signal of the first level. According to an embodiment, the data block 510 may exit from the first mode and enter a second mode. The controller may determine the mode in which the data block 510 exists based on the data signals DTP and DTN. According to an embodiment, the first mode may be the low-power mode, and the second mode may be the high-speed mode.

FIG. 4 illustrates that the first resistance circuit 501 includes the resistor 505 and the switch 507 between the node N1 and the node N2, but the disclosure is not limited thereto. It may also be implemented such that a switch is provided on each of two lines between an input end of the high-speed receiver 511 and the nodes N1 and N2. The controller may also control opening and closing of each switch.

In addition, although the resistance first circuit 501 is described with reference to FIG. 4, the description of the first resistance circuit 501 may be equally applied to the second resistance circuit 502 of FIG. 3.

Referring to FIG. 5, the first to fourth low-power receivers 512, 513, 522, and 523 may receive a first driving current IRD1 though a first switch 531, a second driving current IRD2 though a second switch 532, a third driving current IRD3 though a third switch 533, and a fourth driving current IRD4 though a fourth switch 534. The first to fourth driving currents IRD1, IRD2, IRC1, and IRC2 are currents for driving the first to fourth low-power receivers 512, 513, 522, and 523, and in an example case in which the driving currents IRD1, IRD2, IRC1, and IRC2 are not received, the first to fourth low-power receivers 512, 513, 522, and 523 may not operate. In an embodiment, the first to fourth driving currents IRD1, IRD2, IRC1, and IRC2 may be generated based on a bias current.

The first to fourth switches 531 to 534 may be opened and closed based on control signals PWD2 and PWD3. For example, the controller may generate the control signals PWD2 and PWD3 and transmit the controls signals PWD2 and PWD3 to the switches 531 to 534. The switches 531 to 534 may be closed based on the control signals PWD2 and PWD3 of the first level being received, and may be opened based on the control signals PWD2 and PWD3 of the second level being received. The first level may be the high level, and the second level may be the low level, but the disclosure is not limited thereto.

The controller may turn off the first to fourth low-power receivers 512, 513, 522, and 523 by opening the switches first to fourth 531 to 534. The controller may turn on the first to fourth low-power receivers 512, 513, 522, and 523 by supplying the first to fourth driving currents IRD1, IRD2, IRC1, and IRC2 to the first to fourth low-power receivers 512, 513, 522, and 523 by closing the first to fourth switches 531 to 534.

In an embodiment, in a case in which the power-down indication is received from the transmitter, the controller may generate the control signals PWD2 and PWD3 of the second level. The first to fourth low-power receivers 512, 513, 522, and 523 may be opened based on the control signals PWD2 and PWD3 of the second level. Accordingly, the first to fourth low-power receivers 512, 513, 522, and 523 may be turned off.

In an embodiment, in a case in which the data block 510 enters the first mode, the controller may turn off the third and fourth low-power receivers 522 and 523 of the clock block 520. That is, the controller may generate a control signal PWD3 for opening switches 533 and 534 of the second level and transmit the control signal PWD3 to the switches 533 and 534. The switches 533 and 534 may be opened based on the control signal PWD3 of the second level, and the third and fourth low-power receivers 522 and 523 may be turned off.

In an embodiment, when the data block 510 exits from the first mode, the controller may generate the control signal PWD3 of the first level. The third and fourth low-power receivers 522 and 523 may be turned on based on the control signal PWD3 of the first level. When exiting from the first mode, the data block 510 may enter the second mode. The controller may determine the mode in which the data block 510 exists based on the data signals DTP and DTN. According to an embodiment, the first mode may be the low-power mode, and the second mode may be the high-speed mode.

In some embodiments, when the data block 510 exits from the first mode, the controller may also maintain the control signal PWD3 of the second level.

In this case, the third and fourth low-power receivers 522 and 523 may maintain the turned-off state. The logical area of the receiver 500 may use the output values of the first and second low-power receivers 512 and 513 instead of the output value of the third and fourth low-power receivers 522 and 523, that is, the output values of the third and fourth low-power receivers 522 and 523 may be replaced with the output value of the first and second low-power receivers 512 and 513.

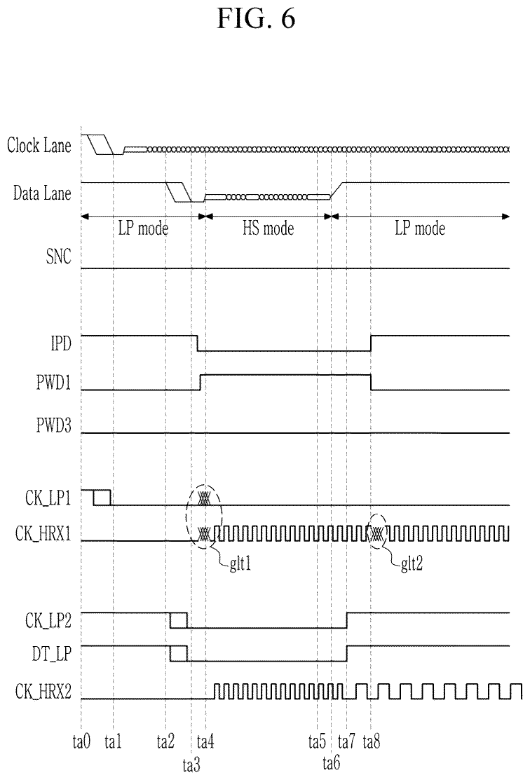

FIG. 6 is a timing diagram for explaining an operation of a receiver according to an embodiment.

Referring to FIG. 6, the receiver according to an embodiment may receive the clock signals through the clock lane, and may receive the data signals through the data lane. The clock lane may correspond to a clock block (e.g., clock block 520 of FIG. 5), the data lane may correspond to a data block (e.g., data block 510 of FIG. 5).

The receiver may receive the clock signals, the data signals, and the synchronization signal SNC from the transmitter. The receiver may generate the operation control signal IPD, the control signal PWD1, and the control signal PWD3 based on the clock signals, the data signals, and the synchronization signal SNC. In the embodiment of FIG. 6, the transmitter may transfer the synchronization signal SNC of the low level to the receiver. That is, the receiver may not turn off all components of the reception circuit.

The clock lane may have a preparation period from a time point ta0 to a time point ta1, and may receive the clock signals toggling from the time point ta1. The data lane may operate in the low-power mode (LP mode) from the time point ta0 to a time point ta4, operate in the high-speed mode (HS mode) from the time point ta4 to a time point ta6, and operate in the low-power mode (LP mode) from the time point ta6. The data lane may have the preparation period for the high-speed mode in a time period ta2 to ta3 and a time period ta3 to ta4. The data lane may be in a stopped state in order to exit from the high-speed mode and enter the low-power mode in a time period ta6 to ta7.

The receiver may generate the operation control signal IPD of the high level in the low-power mode, and may generate the operation control signal IPD of the low level in the high-speed mode. For example, the controller may generate the operation control signal IPD of the high level in a time period ta0 to ta4 and from the time point ta6, and may generate the operation control signal IPD of the low level in a time period ta4 to ta6. The controller may transfer the operation control signal IPD to the reception circuit.

The receiver may generate the control signal PWD1 of the low level based on the operation control signal IPD of the high level, and may generate the control signal PWD1 of the high level based on the operation control signal IPD of the low level. In some embodiments, the operation control signal IPD and the control signal PWD1 may be complementary. According to an embodiment, the control signal PWD1 may be generated by the controller or may be generated by the reception circuit based on the operation control signal IPD.

The controller may turn off the high-speed receiver of the data lane in the time period ta0 to ta4, which is the low-power mode. The controller may turn off the high-speed receiver by opening the switch connected to the input end of the high-speed receiver. According to an embodiment, the controller may also turn off the high-speed receiver of the clock lane. In this case, the controller may also transmit the control signal PWD1 of the high level to the switch connected to the input end of the high-speed receiver of the clock lane.

The controller may turn on the high-speed receiver by closing the switch at the time point ta4 of entering the high-speed mode. As the switch of the clock lane is closed, a glitch glt1 may occur at an output CK_LP1 of the low-power receiver of the clock lane and an output CK_HRX1 of the high-speed receiver.

According to an embodiment, in order to prevent the glitch glt1 of the output CK_LP1, the receiver may use a signal CK_LP2 instead of the output CK_LP1 of the low-power receiver of the clock lane. The signal CK_LP2 may be substantially the same as an output DT_LP of the low-power receiver of the data lane. The receiver may generate the signal CK_LP2 that is the same as the output DT_LP. The receiver may transfer the signal CK_LP2 to the logical area instead of the output CK_LP1 of the low-power receiver of the clock lane. Due to the control signal PWD3 of the low level, the low-power receiver of the clock lane may be turned off from the time point ta0. As the low-power receiver of the clock lane is turned off, the output CK_LP1 of the low-power receiver may be replaced with the signal CK_LP2. According to an embodiment, the receiver may also include a filter for filtering the glitch glt1. The filter may be provided in a physical area.

According to another embodiment, in order to prevent the glitch glt1 of the output CK_HRX1, the receiver may use a signal CK_HRX2 instead of the output CK_HRX1 of the high-speed receiver of the clock lane. The receiver may generate the signal CK_HRX2 from which the glitch glt1 of the output CK_HRX1 is removed at the time point ta4. For example, the receiver may filter the glitch glt1 by using the filter.

In addition, the controller may transmit the control signal PWD1 of the low level to the reception circuit at a time point ta8. The reception circuit may turn off the high-speed receiver by opening the switch of the resistance circuit based on the control signal PWD1 of the low level. As the switch is opened, the glitch glt2 may occur at the output CK_HRX1 of the high-speed receiver.

In an example case in which the level of the output DT_LP of the low-power receiver of the data lane transitions, the receiver may use the internal clock signal instead of the output CK_HRX1. The receiver may generate the internal clock signal by using an internal oscillator. For example, the receiver may use the internal clock signal when the output DT_LP transitions from the low level to the high level at a time point ta7. That is, the receiver may replace the output CK_HRX1 with the internal clock signal. Accordingly, the controller may turn off the high-speed receiver before the glitch glt2 of the clock lane is generated, and the receiver may not be affected by the glitch glt2 of the output CK_HRX1. The receiver may transfer the signal CK_HRX2 generated as such to the logical area.

The receiver may generate the control signal PWD3 of the low level. In some embodiments, the receiver may selectively turn off the low-power receiver of the clock lane, and as needed, may turn on the low-power receiver.

As an example, the receiver may generate the control signal PWD3 of the high level at the low-power mode, and may generate the control signal PWD3 of the low level in the high-speed mode. That is, the controller may generate the control signal PWD3 of the high level at a time period ta0 to ta3, and may generate the control signal PWD3 of the low level in a time period ta3 to ta5. The controller may generate the control signal PWD3 of the high level at a time point ta5 that is prior to the time point ta6 of exiting from the high-speed mode. As the controller turns on the low-power receiver of the clock lane in advance at the time point ta5, the glitch may be prevented when entering the low-power mode after the time point ta6.

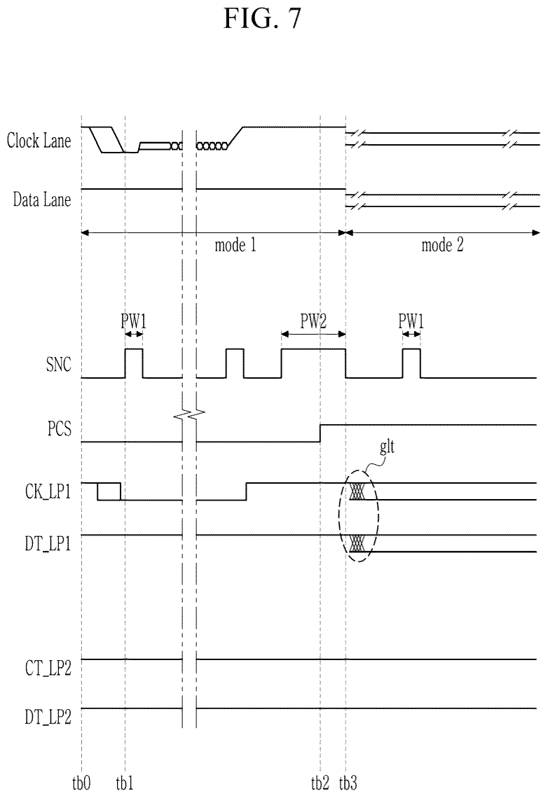

FIG. 7 is a timing diagram for explaining an operation of a receiver according to an embodiment.

Referring to FIG. 7, according to an embodiment, the receiver may operate in a first mode (mode 1) in a time period tb0 to tb3, and may operate in a second mode (mode 2) from a time point tb3. The first mode may be a normal operation mode, and the content described with reference to FIG. 6 may be equally applied to the operation in the first mode. The second mode may be a power-down mode.

The receiver may receive the clock signals through the clock lane, and may receive the data signals through the data lane. The clock lane may correspond to a clock block (e.g., clock block 5200 of FIG. 5), and the data lane may correspond to a data block (e.g., data block 510 of FIG. 5).

The receiver may receive a synchronization signal SNC through a synchronization pin. The synchronization signal SNC may include pulses of various pulses widths PW1 and PW2. The transmitter may transfer control information to the receiver through pulses of various pulse widths PW1 and PW2. A pulse of the first pulse width PW1 may indicate generation of the synchronization signal. For example, the receiver may generate the horizontal synchronization signal or the vertical synchronization signal based on the pulse of the first pulse width PW1 at a time point tb1. In some embodiments, the timing controller or display driving integrated circuit of the receiver may generate the horizontal synchronization signal or the vertical synchronization signal.

According to an embodiment, a pulse of the second pulse width PW2 may indicate power-down. The transmitter may generate the pulse of the second pulse width PW2 for power-down of the transmitter.

The receiver may generate a power control signal PCS based on the synchronization signal SNC and a first reference pulse width. In an example case in which a pulse width greater than the first reference pulse width is detected in the synchronization signal SNC, the receiver may generate the power control signal PCS of the first level. The power control signal PCS of the first level may be a signal for turning off the components of the receiver. For example, the receiver may turn off the high-speed receiver, resistance circuit, the low-power receiver of the clock lane and the data lane. In addition, the receiver may turn off the low-power contention detector and low-power transmitter of the data lane. Although the first level may be the high level and the second level may be the low level, the disclosure is not limited thereto. For example, the controller may detect a pulse width of the synchronization signal SNC to exceed the first reference pulse width at a time point tb2, and may generate the power control signal PCS of the high level. That is, in an example case in which a pulse exceeding the first reference pulse width is detected in the synchronization signal SNC while the receiver is operating, components may be turned off. As the receiver is turned off based on the pulse of the second pulse width PW2, the protocol error may not occur even if the transmitter is powered down.

Since the receiver enters the floating state from the low-power mode when the receiver is turned off, the glitch glt may occur at the output CK_LP1 of the low-power receiver of the clock lane and an output DT_LP1 of the low-power receiver of the data lane. Accordingly, the receiver may use the signal CK_LP2 and a signal DT_LP2. The receiver may generate the signal DT_LP2 by removing the glitch glt of the output DT_LP1. The receiver may generate the signal CK_LP2 that is the substantially the same as the signal DT_LP2.

According to an embodiment, in order to remove the glitch glt caused by the transitioning of the power control signal PCS, the receiver may fix the output CK_LP1 or the output DT_LP1 to a reference value. The reference value may be a predetermined value. For example, in a case in which the power control signal PCS transitions, the receiver may fix the output CK_LP1 or the output DT_LP1 to maintain the previous value. In some embodiments, the receiver may maintain the value of the time point tb2 even after the time point tb2.

Although it is described with reference to FIG. 7 that the synchronization signal SNC includes pulses of the different pulse widths PW1 and PW2, the disclosure is not limited thereto, and as such, according to another embodiment, the synchronization signal SNC may also include pulses of different amplitudes, different toggle counts, or the like. For example, the transmitter may indicate the power-down by using a signal having a different amplitude from a signal indicating generation of the synchronization signal. At this time, the receiver may detect the power-down indication by using a reference amplitude. For example, the transmitter may indicate the power-down by using a signal that toggles by a predetermined count for a predetermined time. The receiver may receive the power-down indication of the transmitter in various forms and be turned off.

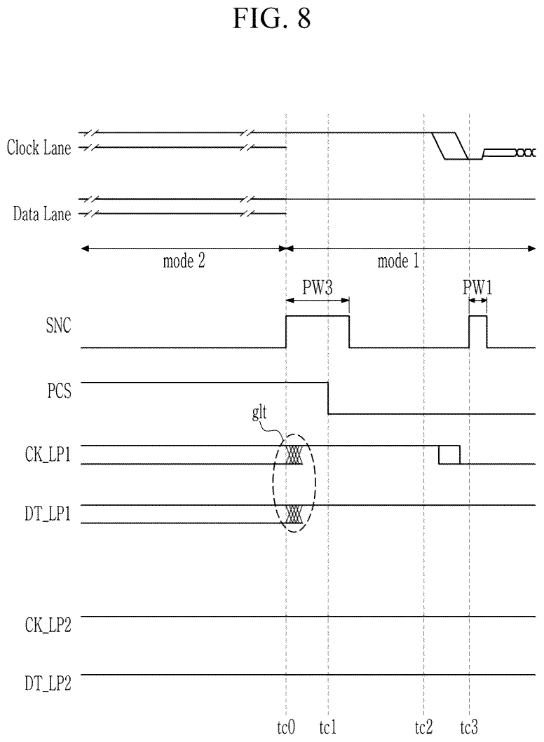

FIG. 8 is a timing diagram for explaining an operation of a receiver according to an embodiment.

Referring to FIG. 8, the receiver according to an embodiment may operate in the second mode until a time point tc0, and may operate in the first mode from the time point tc0. The content described with reference to FIG. 7 may be equally applied to the first mode and the second mode, and redundant description is not included herein.

The receiver may receive the synchronization signal SNC through the synchronization pin. The synchronization signal SNC may include pulses of various pulse widths PW1 and PW3. The transmitter may transfer control information to the receiver through pulse of the various pulse widths PW1 and PW3. The first pulse width PW1 may be the same as the first pulse width PW1 of FIG. 7.

According to an embodiment, a pulse of a third pulse width PW3 may indicate a wake-up. According to an embodiment, the third pulse width PW3 may be same as the second pulse width PW2 of FIG. 7. However, the disclosure is not limited thereto, and as such, according to another embodiment, the third pulse width PW3 may be different from the second pulse width PW2 of FIG. 7.

The receiver may generate the power control signal PCS based on the synchronization signal SNC and a second reference pulse width. In an example case in which the third pulse width PW3 is implemented to be the same as the second pulse width PW2, the second reference pulse width may be implemented to be the same as the first reference pulse width. In an example case in which a pulse width greater than the second reference pulse width is detected in the synchronization signal SNC, the receiver may generate the power control signal PCS of the second level. The power control signal PCS of the second level may be a signal for turning on components of the receiver. For example, the receiver may turn on the low-power receiver of the clock lane and the data lane.

For example, the controller may detect the pulse width of the synchronization signal SNC to exceed the second reference pulse width at a time point tc1, and may generate the power control signal PCS of the low level. That is, when a pulse exceeding the second reference pulse width is detected in the synchronization signal SNC while the receiver is turned off, the low-power receiver may be turned on. As the receiver is turned on based on the pulse of the third pulse width PW3, the protocol error may not occur even if the transmitter is turned on.

The transmitter staying in the floating state may transfer the data signals and the clock signals to the receiver at the time point tc0. The receiver may exit from the second mode and enter the first mode at the time point tc0. According to the state change of the transmitter, the glitch glt may occur at the output CK_LP1 and the output DT_LP1.

Accordingly, the receiver may generate and use the signal CK_LP2 and the signal DT_LP2. The receiver may generate the signal DT_LP2 by removing the glitch glt of the output DT_LP1. The receiver may generate the signal CK_LP2 that is the substantially the same as the signal DT_LP2.

According to an embodiment, in order to remove the glitch glt caused by the transitioning of the power control signal PCS, the receiver may fix the output CK_LP1 or the output DT_LP1 to a reference value. The reference value may be a predetermined value. In an example case in which the power control signal PCS transitions, the receiver may fix the output CK_LP1 or the output DT_LP1 to maintain the previous value. In an embodiment, the receiver may maintain the value prior to the time point tc0 even after a time point tc1.

In an example case in which the power control signal PCS transitions, the receiver may transfer the output CK_LP1 or the output DT_LP1 to the logical area after a reference time. The reference time may be predetermined. For example, the receiver may delay the output CK_LP1 or the output DT_LP1 by using a delay chain. In another example case in which the pulses of the first pulse width PW1 of the synchronization signal SNC are counted a predetermined number of times after the transmitter phase-locked loop (PLL) circuit and the bias circuit are turned on, the receiver may transfer the output CK_LP1 or the output DT_LP1 to the logical area. As a still another example, the receiver may transfer the output CK_LP1 or the output DT_LP1 to the logical area after the internal clock signal toggles a predetermined number of times. Accordingly, the signal CK_LP2 and the signal DT_LP2 from which the glitch glt is alleviated may be generated.

In the same way as in FIG. 7, the synchronization signal SNC may also be implemented to include pulses of different amplitudes, different pulse counts, different toggle counts, or the like.

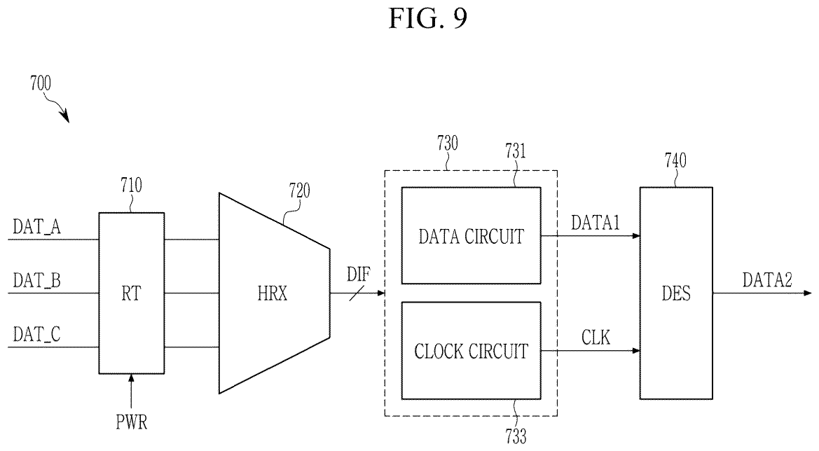

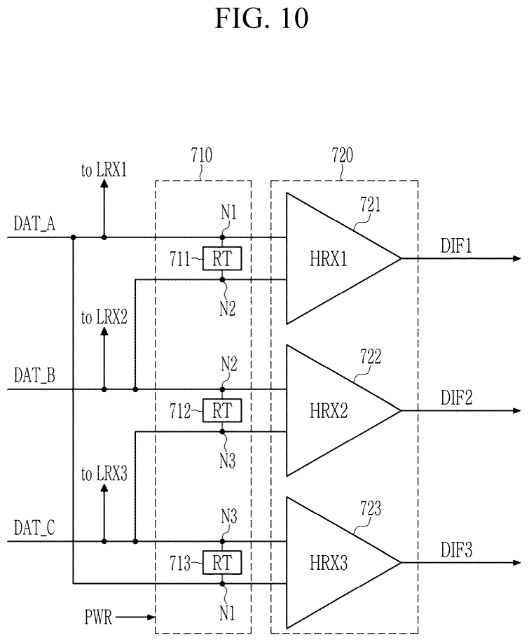

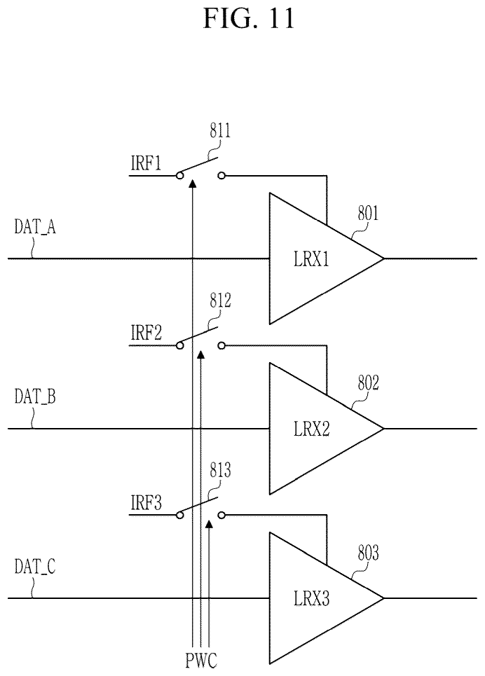

FIG. 9 is a block diagram of a receiver according to an embodiment. FIG. 10 is a block diagram of the reception circuit according to an embodiment. FIG. 11 is a circuit diagram of the low-power receiver according to an embodiment.

Referring to FIG. 9, a receiver 700 according to an embodiment may be included in the physical area of C-PHY. According to an embodiment, the receiver 700 may be a block diagram showing the clock lane among three lanes receiving signals from the transmitter. The receiver 700 may receive signals DAT_A, DAT_B, and DAT_C in a continuous clock mode.

The receiver 700 may include a resistance circuit (RT) 710, a high-speed speed receiver (HRX) 720, a restoration circuit 730, and a deserializer (DES) 740. The receiver 700 may further include the low-power receiver, and the low-power receiver will be described later with reference to FIG. 11.

The receiver 700 may receive the signals DAT_A, DAT_B, and DAT_C, and may perform operations according to the signals DAT_A, DAT_B, and DAT_C. The signals DAT_A, DAT_B, and DAT_C may have different phases. For example, the signals DAT_A, DAT_B, and DAT_C may be understood as a first phase signal, a second phase signal, and a third phase signal, respectively. In an embodiment, first to third phase signals may be represented by using the states of +1, 0, and −1. The states of +1, 0, and −1 may mean three voltage levels +V, 0, −V, or three voltage levels +V, +V/2, 0, or three voltage levels +¼V, +½V, +¾V, or three current I, 0, −I, but the disclosure is not limited thereto.

The high-speed receiver 720 may receive the signals DAT_A, DAT_B, and DAT_C. The high-speed receiver 720 may generate the differential signals DIF based on the signals DAT_A, DAT_B, and DAT_C. For example, the high-speed receiver 720 may generate the differential signals DIF based on an amplitude difference of two signals among the signals DAT_A, DAT_B, and DAT_C.

The resistance circuit 710 may be connected to an input end of the high-speed receiver 720. The resistance circuit 710 may include a switch that opens and closes based on a control signal PWR. The controller of the logical area may generate the control signal PWR. In an example case in which the data lane among the three lanes enters the high-speed mode or exits the low-power mode, the controller may generate the control signal PWR of the first level. In an example case in which the data lane enters the low-power mode or exits the high-speed mode, the controller may generate the control signal PWR of the second level. The first level may be the high level, and the second level may be the low level, but the disclosure is not limited thereto. The switch may be closed based on the control signal PWR of the first level, and may be opened based on the control signal PWR of the second level. As the switch of the resistance circuit 710 is opened and closed, the high-speed receiver 720 may be turned on and off.

Referring to FIG. 10, the high-speed receiver 720 according to an embodiment may include a first high-speed reception circuit (HRX1) 721, a second high-speed reception circuit (HRX2) 722, and a third high-speed reception circuit (HRX3) 723. The first high-speed reception circuit 721 may generate a first differential signal DIF1 based on an amplitude difference of the signals DAT_A and DAT_B, and the second high-speed reception circuit 722 may generate a second differential signal DIF2 based on an amplitude difference of the signals DAT_B and DAT_C, and the third high-speed reception circuit 723 may generate a third differential signal DIF3 based on an amplitude difference of the signals DAT_C and DAT_A. The first to third differential signals DIF1 to DIF3 may be a digital value, and the high-speed receiver 720 may include a Direct Current (DC) comparator for generating the digital value.

According to an embodiment, the resistance circuit 710 may include a first resistance circuit 711, a second resistance circuit 712, and a third resistance circuit 713. The first resistance circuit 711 may be provided between a node N1 and a node N2, the second resistance circuit 712 may be provided between the node N2 and a node N3, and the third resistance circuit 713 may be provided in between the node N3 and the node N1. Nodes N1 to N3 may correspond to input ends of first to third high-speed reception circuits 721 to 723, respectively. The contents on the first resistance circuit 501 described with reference to FIG. 4 may be equally applied to each of the first resistance circuit 711, second resistance circuit 712, and the third resistance circuit 713. The resistance circuit 710 may be opened and closed based on the control signal PWR, to turn the high-speed receiver 720 on and off.

Each of the signals DAT_A, DAT_B, and DAT_C may be input in the low-power receivers LRX1 to LRX3. Referring to FIG. 11, a first low-power receiver (LRX1) 801 may receive the signal DAT_A, a second low-power receiver (LRX2) 802 may receive the signal DAT_B, and a third low-power receiver (LRX3) 803 may receive the signal DAT_C. The first to third low-power receivers 801 to 803 may receive driving currents IRF1 to IRF3 through switches 811 to 813. The driving currents IRF1 to IRF3 are currents for driving the first to third low-power receivers 801 to 803, and when the driving currents IRF1 to IRF3 are not received, the first to third low-power receivers 801 to 803 may not operate. In an embodiment, the driving currents IRF1 to IRF3 may be generated based on a bias current.

In an example case in which the power-down indication is received from the transmitter, the controller may generate a control signal PWC of the second level. The switches 811 to 813 may be opened and closed based on the control signal PWC. For example, the controller may generate the control signal PWC and transmit the control signal PWC to the switches 811 to 813. The switches 811 to 813 may be closed when the control signal PWC of the first level is received, and may be opened when the control signal PWC of the second level is received. The first level may be the high level, and the second level may be the low level, but the disclosure is not limited thereto.

The controller may turn off the first to third low-power receivers 801 to 803 by opening the switches 811 to 813. The controller may turn on the first to third low-power receivers 801 to 803 by supplying the driving currents IRF1 to IRF3 to the first to third low-power receivers 801 to 803 by closing the switches 811 to 813.

Referring back to FIG. 9, the restoration circuit 730 may generate first data DATA1 and the clock CLK based on the differential signals DIF. For example, the restoration circuit 730 may include a data circuit 731 configured to generate the first data DATA1 from the differential signals DIF and a clock circuit 733 configured to generate the clock CLK from the differential signals DIF. The clock CLK may be the clock signal embedded in the signals DAT_A, DAT_B, and DAT_C. The clock circuit 733 may extract the embedded clock signal from the differential signals DIF. The clock circuit 733 may transfer the clock CLK to the deserializer 740.

In some embodiments, the restoration circuit 730 may be implemented to include a component configured to search and fix the phase and frequency of the clock CLK through a feedback loop such as a phase-locked loop (PLL) or a delay-locked loop (DLL). The restoration circuit 730 may include a phase detector for restoring the clock CLK.

The restoration circuit 730 may further include a delay circuit connected to the data circuit 731 and configured to delay the first data DATA1. According to an embodiment, the delay circuit may also be provided in an exterior of the restoration circuit 730. The restoration circuit 730 may transfer the first data DATA1 and the clock CLK to the deserializer 740.

The deserializer 740 may receive the first data DATA1 and the clock CLK. The deserializer 740 may deserialize the first data DATA1 based on the clock CLK. The deserializer 740 may deserialize the first data DATA1 and generate second data DATA2. For example, the first data DATA1 may be a bit sequence, and the second data DATA2 may be a plurality of bit values included in the bit sequence. The deserializer 740 may transfer the second data DATA2 to the logical area. In an embodiment, the resistance circuit 710, the high-speed receiver 720, the restoration circuit 730, and the deserializer 740 may be included in a physical area. The controller of the logical area may determine a wire state based on the second data DATA2. For example, the wire states may include +x, −x, +y, −y, +z, and −z. The controller may determine a delay code based on a transition of the wire state. The delay code may be input to the delay circuit of the restoration circuit 730 and be used for the skew calibration.

According to an embodiment, the deserializer 740 may also be implemented as a serial/parallel converter such as a serializer-deserializer (SerDes). The deserializer 740 may include at least one of a parallel-in serial-out (PISO) block or a serial-in parallel-out (SIPO) block.

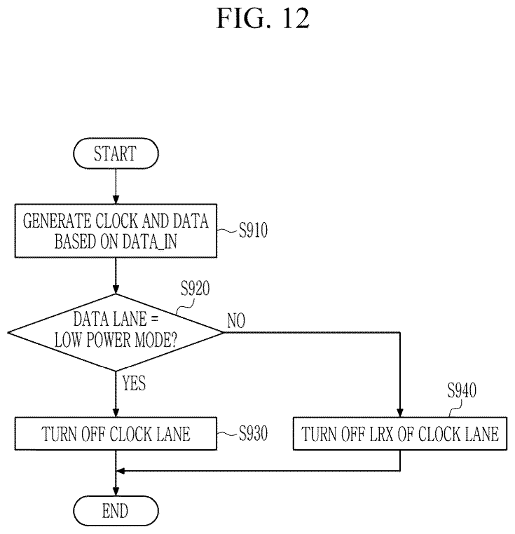

FIG. 12 is a flowchart of a power managing method of a receiver according to an embodiment.

Referring to FIG. 12, according to an embodiment, the receiver may receive input data DATA_IN from the transmitter. The receiver may be implemented with a physical layer D-PHY or C-PHY, and operate in compliance with the physical layer D-PHY or C-PHY protocol defined by the MIPI alliance. The receiver may include the high-speed receiver and the low-power receiver.

According to an embodiment, in operation S910, the method may include generating a clock and data based on the input data. For example, the receiver may generate clock and data based on the input data DATA_IN. In an embodiment, in an example case in which the receiver is D-PHY, the receiver may include a clock circuit (or a clock lane) for generating the clock signal and a data circuit (or a data lane) for generating the data signal. In an embodiment, in an example case in which the receiver is C-PHY, the receiver may include a clock circuit for extracting the embedded clock signal from the input data DATA_IN and a data circuit for extracting the data signal.

In operation S920, the method may include determining an operation mode of the data lane. For example, the receiver may determine whether the data lane is in the low-power mode. For example, the controller of the logical area may receive the data signal from the physical area, and may determine whether the data lane is in the low-power mode or in the high-speed mode. For example, the receiver may determine a state code based on the data signal received through the low-power receiver. The receiver may determine the mode of the data lane based on a change of the state code.

In operation S930, the method may include turning off the clock lane based on the data lane being in the low-power mode. For example, in a case in which the data lane is in the low-power mode, the receiver may turn off the clock lane. In some embodiments, the receiver may also turn off the at least one among the low-power receiver and the high-speed receiver of the clock lane. In an example case in which the receiver is D-PHY, the controller may turn off the low-power receiver and the high-speed receiver of the clock lane. In an example case in which the receiver is C-PHY, the controller may turn off the low-power receiver and the high-speed receiver corresponding to the clock lane among three lanes. The receiver may turn off the high-speed receiver by opening the switch of the resistance circuit connected to the input end of the high-speed receiver. The receiver may turn off the low-power receiver by opening the switch for transferring driving current to the low-power receiver.

In operation S940, the method may include turning off a low-power receiver based on the data lane not being in the low-power mode. For example, in a case in which the data lane is not in the low-power mode, the receiver may turn off the low-power receiver LRX of the clock lane. The receiver may turn off the low-power receiver LRX, and may use the output of the low-power receiver of the data lane, instead. In some embodiments, the receiver may selectively turn-off the low-power receiver LRX of the clock lane. That is, in some embodiments, the receiver may not turn off the low-power receiver LRX of the clock lane even in a case in which the data lane is not in the low-power mode.

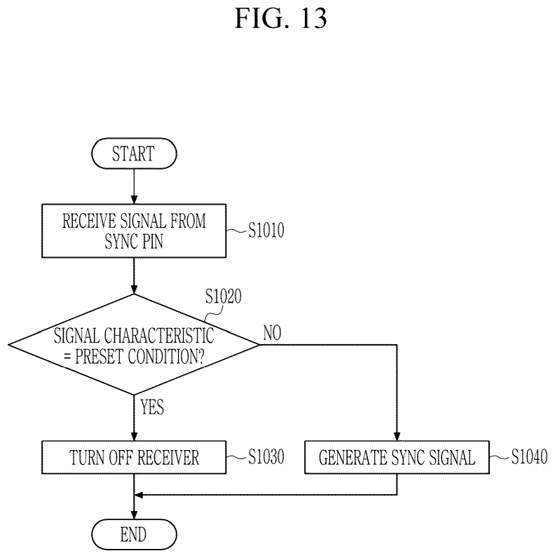

FIG. 13 is a flowchart of a power managing method of a receiver according to an embodiment.

Referring to FIG. 13, in operation S1010, the method may include receiving a signal. For example, the receiver may receive the signal (e.g., the synchronization signal) from a synchronization pin SYNC PIN. The synchronization pin may be different from data pin. The receiver may receive data or clock from the transmitter through the data pin, and may receive the synchronization signal through the synchronization pin. The synchronization signal may include pulses of different properties. For example, the synchronization signal may include the pulse of the first pulse width and the pulse of the second pulse width. The pulse of the first pulse width may indicate generation of the synchronization signal, and the pulse of the second pulse width may indicate power-down. The pulse of the first pulse width may have periodicity in the synchronization signal. However, the disclosure is not limited thereto, and as such, according to another embodiment, the synchronization signal may have properties of pulses of different amplitudes, pulses of different duty ratio, or the like.

In operation S1020, the method may include determining whether a signal characteristic satisfies a condition. For example, the receiver may determine whether a signal characteristic satisfies a preset condition. For example, the receiver may determine whether the pulse width of the synchronization signal exceeds the reference pulse width. The reference pulse width may be greater than the first pulse width and smaller than the second pulse width. However, the disclosure is not limited thereto, and as such, according to another embodiment, the condition may be different than whether the pulse width of the synchronization signal exceeds the reference pulse width.

In operation S1030, the method may include turning off the receiver based on the signal characteristic satisfying the preset condition. For example, in a case in which the signal characteristic satisfies the preset condition, the receiver may turn off the receiver. For example, the receiver may turn off the high-speed receiver of the clock lane and the data lane, the resistance circuit connected to the high-speed receiver, and the low-power receiver. In addition, the receiver may also turn off the low-power contention detector and low-power transmitter of the data lane.

In operation S1040, the method may include generating a synchronization signal SYNC signal based on the signal characteristic not satisfying the preset condition. For example, in a case in which the signal characteristic does not satisfy the preset condition, the receiver may generate the synchronization signal SYNC signal. The receiver may generate the horizontal synchronization signal or the vertical synchronization signal. For example, a timing controller or a display driving integrated circuit may generate the synchronization signal.

In addition, in an example case in which the synchronization signal exceeding the reference pulse width is received in the turn-off state, the receiver may be turned on. According to an embodiment, the reference pulse width (e.g., the first reference pulse width) for turn off the receiver may be different from the reference pulse width (e.g., the second reference pulse width) for turning on may be implemented to be different.

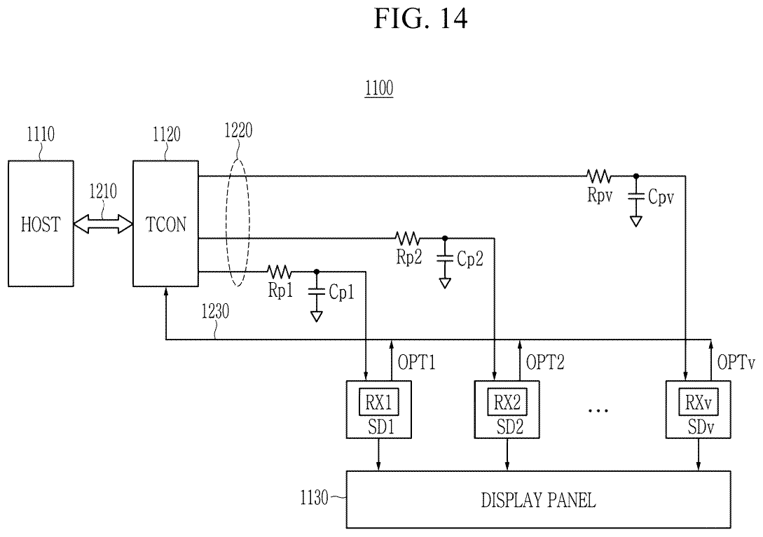

FIG. 14 is a block diagram showing an electronic system including a receiver according to an embodiment.

FIG. 14 shows an electronic system 1100 including a display driving circuit. For better comprehension and ease of description, a display panel 1130 is also shown together.

Referring to FIG. 14, display driving circuit may include a timing controller (TCON) 1120, a plurality of source drivers SD1 to SDv, a plurality of data transmission channels 1220 and a shared back channel 1230.

The timing controller 1120 may transmit data to the plurality of source drivers SD1 to SDv. The data transmitted to the plurality of source drivers SD1 to SDv may be packet data including display data. Each of the plurality of source drivers SD1 to SDv may drive one or more data line of the display panel 1130 based on the received data.

The timing controller 1120 may transmit data to the plurality of source drivers SD1 to SDv and receive data from the plurality of source drivers SD1 to SDv through the high-speed serial interface method. The interface method between the timing controller 1120 and the plurality of source drivers SD1 to SDv may be called an intra panel interface.

In addition, the timing controller 1120 may transmit data to a host device 1110 and receive data from the host device 110 through a communication channel 1210 through the high-speed serial interface method. The interface method between the timing controller 1120 and the host device 1110 may be called an inter panel interface.

The timing controller 1120 may determine the operation mode based on the data of the host device 1110. The timing controller 1120 may turn off component based on the operation mode. For example, the configuration and operation of the receiver described with reference to FIG. 1 to FIG. 13 may be equally applied to the timing controller 1120. That is, the timing controller 1120 may determine the operation mode based on the data of the data lane received through the communication channel 1210. In an example case in which the operation mode of the data lane is the low-power mode, the timing controller 1120 may turn off the high-speed receiver of the data lane and the clock lane, the resistance circuit connected to the high-speed receiver, and the low-power receiver. In addition, the timing controller 1120 may also turn off the low-power contention detector and low-power transmitter of the data lane. In an example case in which the operation mode of the data lane is the high-speed mode, the timing controller 1120 may turn on the high-speed receiver and resistance circuit of the data lane and the clock lane.

The timing controller 1120 may be connected to the plurality of source drivers SD1 to SDv in the point-to-point method, and may transmit data to each of the plurality of source drivers SD1 to SDv through different data transmission channels 1220. The timing controller 1120 may transmit data to the respective source drivers through respective transmission channels.

The distances from the timing controller 1120 to the plurality of source drivers SD1 to SDv may be different from each other. Therefore, lengths of the transmission channels 1220 may be different from each other, and parasitic resistances Rp1 to Rpv and parasitic capacitors Cp1 to Cpv of the respective transmission channels 1220 may be different from each other.

Accordingly, since the impedance and frequency properties of the transmission channels 1220 are different, the plurality of source drivers SD1 to SDv may perform training for optimizing reception operation according to the impedance and frequency characteristics of the corresponding transmission channel.

In more detail, each of the plurality of source drivers SD1 to SDv may optimize the reception operation of the receivers RX1 and RXv through the training. In addition, the plurality of source drivers SD1 to SDv may determine parameter values OPT1 and OPTv of the receivers RX1 and RXv for optimizing each reception operation, and may transmit the parameter values OPT1 and OPTv to a timing controller 1110.

In an embodiment, each of the plurality of source drivers SD1 to SDv may transmit the parameter values OPT1 and OPTv to the timing controller 1110, based on a read command received from the timing controller 1110.

Meanwhile, the plurality of source drivers SD1 to SDv may be connected to the timing controller 1120 in a multi-drop manner through the shared back channel 1230. In an embodiment, the shared back channel 1230 may be configured as one signal line. The plurality of source drivers SD1 to SDv may sequentially transmit the parameter values OPT1 and OPTv to the timing controller 1120 through the shared back channel 1230. In an example case in which an abnormal state in connection with the reception operation occurs, in other words, when a reception abnormality state, occurs, at least one source driver among the plurality of source drivers SD1 to SDv may transmit a state information signal representing the abnormal state to the timing controller 1120 through the shared back channel 1230.

The electronic system 1100 according to an embodiment may include a first device including a transmission circuit and a second device including a receiver for generating the above-described the delay code.

In an embodiment, the first device may be the host device 1110 configured to output display data to the communication channel 1210 as transmission data, and the second device may be a display device configured to display an image based on the display data. In this case, the receiver according to an embodiment may be included in the timing controller 1120 of the display device.

In another embodiment, the first device may be the timing controller 1120, and the second device may be the source drivers SD1 to SDv of the display device. In this case, the receivers RX1 and RXv may be included in the source drivers SD1 to SDv.

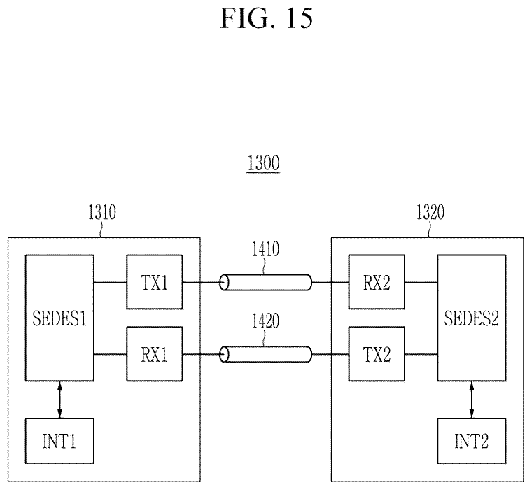

FIG. 15 is a block diagram showing an electronic system including a receiver according to an embodiment.

FIG. 15 shows a system performing a bi-directional communication. Referring to FIG. 15, an electronic system 1300 may include electronic devices 1310 and 1320. According to an embodiment, each of the electronic devices 1310 and 1320 may be implemented as one of various electronic devices such as a desktop computer, a laptop computer, a tablet computer, a smart phone, a wearable device, a video game console, a home appliance, a medical device, or the like.

However, the disclosure is not limited thereto, and as such, according to another embodiment, the electronic system 1300 may be implemented as a single electronic device. In these embodiments, each of the electronic devices 1310 and 1320 may be a component or intellectual property (IP) included in the single electronic device, and may be implemented as an object in the level of circuits, modules, chips, and/or packages. Terms of system and device are provided for enabling better understanding, and do not intend to limit the embodiments of the disclosure.

The electronic devices 1310 and 1320 may communicate with each other, and may exchange data/signals through communication channels 1410 and 1420. Each of the communication channels 1410 and 1420 may include a conductive material in order to transfer data/signals. As an example, each of the communication channels 1410 and 1420 may be implemented with a trace pattern on a PCB, a conductor of a cable, a metal pin/pad of a connector, or the like. Although FIG. 15 illustrates two one-way communication channels 1410 and 1420, the disclosure is not limited thereto, and as such, according to another embodiment, the two one-way communication channels 1410 and 1420 may be integrated into one bi-directional communication channel.

The electronic device 1310 may include an internal circuit INT1, a serializer/deserializer SEDES1, a transmission circuit TX1 and a reception circuit RX1. An electronic device 1320 may include an internal circuit INT2, a serializer/deserializer SEDES2, a transmission circuit TX2 and a reception circuit RX2. Each of the components in the electronic devices 1310 and 1320 configured to perform various operations.

For example, the internal circuits INT1 and INT2 may operate in order to provide unique functions of the electronic devices 1310 and 1320. As an example, the internal circuits INT1 and INT2 may constitute various configuration components or IPs such as a processor (e.g., central processing unit (CPU), application processor (AP), or the like), memory, an image sensor, a display, or the like.

The electronic devices 1310 and 1320 may be implemented as separate components, IPs, or devices. Therefore, the electronic device 1310 may be an external device with respect to the electronic device 1320, and the electronic device 1320 may be an external device with respect to the electronic device 1310.

The serializer/deserializer SEDES1 may serialize the data generated according to operations of the internal circuit INT1 and provide it to the transmission circuit TX1. The transmission circuit TX1 may transmit the serialized signal to the electronic device 1320 through the communication channel 1410. The reception circuit RX2 may equalize the signal received through the communication channel 1410, and may restore the clock and data based on the equalized signal. The serializer/deserializer SEDES2 may deserialize the signal provided from the reception circuit RX2 and provide deserialized data.

Meanwhile, the serializer/deserializer SEDES2 may serialize the data generated according to operations of the internal circuit INT2 and provide it to the transmission circuit TX2. The transmission circuit TX2 may transmit the serialized signal to the electronic device 1310 through a communication channel 1420. The reception circuit RX1 may equalize the signal received through the communication channel 1420, and may restore the clock and data based on the equalized signal. The serializer/deserializer SEDES1 may deserialize the signal provided from the reception circuit RX1 and provide deserialized data.

In this way, the electronic devices 1310 and 1320 may exchange data/signals with each other through the communication channels 1410 and 1420. When the communication speed between the electronic devices 1310 and 1320 increases (e.g., when the communication is performed in a higher frequency or bandwidth), the electronic devices 1310 and 1320 may exchange more amount of data during a unit time.

However, due to various factors such as a skin effect, a dielectric loss, or the like, each of the communication channels 1410 and 1420 may exhibit low-pass frequency response characteristics. Therefore, in the high speed operation, bandwidths of the communication channels 1410 and 1420 may be limited, and may be smaller than the bandwidth of signals. This may weaken high-frequency components of the signals transferred through the communication channels 1410 and 1420, and may cause an inter-symbol interference ISI in the time domain. As a result, as the speed for transferring signals becomes higher, the distortion of signals may be strengthened, and the quality of signals may be deteriorated.

According to an embodiment, at least one of the reception circuits RX1 and RX2 may turn off the components in order to reduce power consumption. For example, the configuration and operation of the receiver described with reference to FIG. 1 to FIG. 13 may be equally applied to at least one of the reception circuits RX1 and RX2. That is, the reception circuits RX1 and/or RX2 may determine the operation mode based on the data of the data lane received through the communication channels 1410 and 1420. When the operation mode of the data lane is the low-power mode, the reception circuits RX1 and/or RX2 may turn off the high-speed receiver of the data lane and the clock lane, the resistance circuit connected to the high-speed receiver, and the low-power receiver. In addition, the reception circuits RX1 and/or RX2 may also turn off the low-power contention detector and low-power transmitter of the data lane. When the operation mode of the data lane is the high-speed mode, the reception circuits RX1 and/or RX2 may turn on the high-speed receiver and resistance circuit of the data lane and the clock lane.

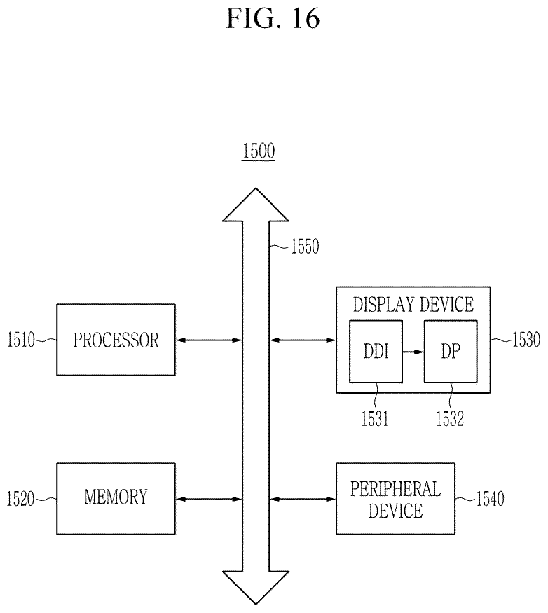

FIG. 16 is a drawing for explaining a semiconductor system according to an embodiment.

Referring to FIG. 16, according to an embodiment, a semiconductor system 1500 may include a processor 1510, a memory 1520, a display device 1530, and a peripheral device 1540 that are electrically connected to a system bus 1550.

The processor 1510 may control input/output of data of the memory 1520, the display device 1530, and the peripheral device 1540, and may perform image processing of the image data transmitted between corresponding devices.

The display device 1530 may include a display driver IC (DDI) 1531 and a display panel (DP) 1532. The display device 1530 may store the image data received through the system bus 1550 into the display driver IC1531, for example, in a frame memory included in the display driver IC1531, and then display the image on the display panel 1532 based on the image data.

The receiver described with reference to FIG. 1 to FIG. 13 may be integrated into the DDI 1531. That is, the receiver may determine the operation mode based on the data of the data lane received through the communication channel. When the operation mode of the data lane is the low-power mode, the receiver may turn off the high-speed receiver of the data lane and the clock lane, the resistance circuit connected to the high-speed receiver, and the low-power receiver. In addition, the receiver may also turn off the low-power contention detector and low-power transmitter of the data lane. When the operation mode of the data lane is the high-speed mode, the receiver may turn on the high-speed receiver and resistance circuit of the data lane and the clock lane.

The peripheral device 1540 may be a device configured to convert a motion picture a still image, or the like, to an electrical signal, such as a camera, a scanner, a webcam, or the like. The image data obtained through the peripheral device 1540 may be stored in the memory 1520, and/or may be displayed on the display panel 1532 in real time.

The memory 1520 may include a volatile memory such as a dynamic random-access memory (DRAM) and/or a non-volatile memory such as a flash memory. The memory 1520 may be configured as a DRAM, a phase-change random-access memory (PRAM), a magnetic random-access memory (MRAM), a resistive random-access memory (ReRAM), a ferroelectric random-access memory (FRAM), a NOR flash memory, a NAND flash memory, and a fusion flash memory (e.g., a memory in which a static random-access memory (SRAM) buffer, a NAND flash memory, and a NOR interface logic are combined), or the like. The memory 1520 may store the image data obtained from the peripheral device 1540 or store the video signal processed by the processor 1510.

A semiconductor system 1500 may be provided to a mobile electronic product such as a smart phone, a tablet, or the like, but is not limited thereto, and may be provided to various types of electronic products displaying images.

In some embodiments, each component or combinations of two or more components described with reference to FIG. 1 to FIG. 16 may be implemented as a digital circuit, a programmable or non-programmable logic device or array, an application-specific integrated circuit (ASIC), or the like.

While this disclosure has been described in connection with example embodiments, it is to be understood that the disclosure is not limited to the example embodiments, but, on the contrary, is intended to cover various modifications and equivalent arrangements included within the spirit and scope of the appended claims.

What is claimed is:

1. A receiving device comprising:
a reception circuit provided in a physical area of the receiving device, the reception circuit configured to:
generate data based on a differential signals received from a transmitter, and
transfer the data to a logical area of the receiving device; and
a controller provided in the logical area, the controller configured to:
determine an operation mode based on the data,
generate an operation control signal based on the operation mode, and
transfer the operation control signal to the reception circuit.

2. The receiving device of claim 1, wherein the reception circuit comprises:
a high-speed receiver configured to:
receive a first signal and a second signal, which are the differential signals, and
generate first data based on the first signal and the second signal;
a first low-power receiver configured to:
receive the first signal, and
generate second data based on the first signal; and
a second low-power receiver configured to:
receive the second signal, and
generate third data based on the second signal.

3. The receiving device of claim 2, wherein the controller is further configured to:
generate the operation control signal having a first level based on the operation mode being a low-power mode, and
generate the operation control signal having a second level based on the operation mode being a high-speed mode.

4. The receiving device of claim 3, wherein the controller is further configured to turn off the high-speed receiver based on the operation control signal being the first level, and turn on the high-speed receiver based on the operation control signal being the second level.

5. The receiving device of claim 4, wherein the controller is further configured to turn the high-speed receiver on or off by opening or closing a first switch connected to an input end of the high-speed receiver.

6. The receiving device of claim 4, wherein the controller is further configured to turn off at least one of the first and the second low-power receivers based on the operation control signal being the first level.

7. The receiving device of claim 6, wherein the controller is further configured to turn at least one of the first and the second low-power receivers on or off by opening or closing a second switch for transferring a driving current to the at least one of the first and the second low-power receivers.

8. The receiving device of claim 1, wherein the controller is further configured to:
receive a pulse signal from the transmitter through a synchronization pin; and
turn off the reception circuit based on a width of the pulse signal exceeding a reference pulse width while the reception circuit is operating.

9. The receiving device of claim 8, wherein the controller is further configured to turn on the reception circuit based on the width of the pulse signal exceeding the reference pulse width while the reception circuit is turned off.

10. The receiving device of claim 8, wherein the controller is further configured to:
generate a horizontal synchronization signal or a vertical synchronization signal based on the width of the pulse signal being smaller than the reference pulse width.

11. The receiving device of claim 1, wherein the reception circuit is further configured to:
generate a clock from signals received from the transmitter; and
replace the clock with an internal clock signal based on an output of a low-power receiver of the reception circuit transitioning from a second level to a first level.

12. The receiving device of claim 1, wherein:
the receiving device complies with D-PHY protocol of Mobile Industry Processor Interface (MIPI) alliance,
the reception circuit comprises a data lane and a clock lane,
the data lane is configured to generate the data from data signals received from the transmitter,
the clock lane is configured to generate a clock from clock signals received from the transmitter, and
the controller is further configured to turn off the reception circuit of the clock lane based on the operation mode being a low-power mode.

13. The receiving device of claim 12, wherein the controller is further configured to turn on a high-speed receiver of the clock lane based on the operation mode being a high-speed mode.

14. The receiving device of claim 12, wherein the controller is further configured to maintain a low-power receiver of the clock lane to be turned off based on the operation mode being a high-speed mode.

15. The receiving device of claim 1, wherein:
the receiving device complies with the C-PHY protocol of Mobile Industry Processor Interface (MIPI) alliance;
the reception circuit comprises a clock lane operating as a continuous clock mode and two data lanes receiving the data from the transmitter; and
the controller is further configured to turn off the clock lane based on the operation mode of the data lane being a low-power mode.

16. A power managing method of a receiving device, comprising:
generating, by a data lane of the receiving device, data based on a first input signal;
generating, by a clock lane of the receiving device, a clock based on a second input signal;
determining, by the data lane, an operation mode of the data lane based on the data; and
turning off a low-power receiver of the clock lane based on the operation mode being a low-power mode.

17. The power managing method of claim 16, further comprising turning off a high-speed receiver of the clock lane based on the operation mode being the low-power mode.

18. The power managing method of claim 17, further comprising turning on the high-speed receiver based on the data lane transitioning from the low-power mode to a high-speed mode.

19. A power managing method of a receiving device, comprising:
receiving a pulse signal from a synchronization pin;
determining whether a signal characteristic of the pulse signal satisfies a first condition;
turning off a receiver of the receiving device based on the signal characteristic satisfying the first condition; and
generating a synchronization signal based on the signal characteristic not satisfying the first condition.

20. The power managing method of claim 19, wherein the determining whether the signal characteristic of the pulse signal satisfies the first condition comprises determining whether a pulse width of the pulse signal is greater than a reference pulse width or whether an amplitude of the pulse signal is greater than a reference amplitude.
